(19) United States
(12) Patent Application Publication
(10) Pub. No.: US 2023/0122644 A1
(43) Pub. Date: Apr. 20, 2023

(54) SENSOR FOR MEASURING A PH VALUE OF A MEASURING LIQUID

(71) Applicant: Endress+Hauser Conducta GmbH+Co. KG, Gerlingen (DE)

(72) Inventors: Thomas Wilhelm, Chemnitz (DE); Andreas Löbbert, Waldheim (DE); Matthäus Speck, Gopfersdorf (DE)

(21) Appl. No.: 18/048,241

(22) Filed: Oct. 20, 2022

(30) Foreign Application Priority Data
Oct. 20, 2021 (DE) 10 2021 127 233.5

(51) Int. Cl. G01N 21/80

(52) U.S. Cl. CPC G01N 21/80

(57) ABSTRACT

A sensor for measuring a pH value of a measuring liquid includes: a sensor element comprising a surface adapted to contact the measuring liquid; a radiation source configured to emit electromagnetic transmission radiation reaching the sensor element, wherein at least a portion of the transmission radiation is converted into measuring radiation by reflection and/or scattering in the region of the surface; a radiation receiver configured to receive the measuring radiation and convert it into electrical signals; and a measuring circuit connected to the radiation receiver and configured to determine a measured value representing the pH value of the measuring liquid from signals of the radiation receiver, wherein the surface adapted to contact the measuring liquid includes a pH-sensitive component and a SERS-active component.

The present application is related to and claims the priority benefit of German Patent Application No 10 2021 127 233.5, filed on Oct. 20, 2021, the entire contents of which are incorporated herein by reference.

### TECHNICAL FIELD

The present disclosure relates to a sensor for measuring a pH value of a liquid.

### BACKGROUND

The measurement of the pH value of a measuring liquid plays a major role in the laboratory, in environmental analysis and in process measurement technology. Predominantly, potentiometric sensors having a pH-sensitive measurement half-cell and a potential-stable reference half-cell are used for pH measurement. A glass electrode having a membrane made of pH-selective glass is suitable as a pH-sensitive measurement half-cell. Although such potentiometric pH sensors provide very accurate measurement results, they are relatively susceptible to faults and require intensive maintenance. Typical faults of potentiometric sensors with conventional glass electrodes include mechanical damage or chemical aging of the glass membrane.

pH-ISFET sensors or potentiometric sensors having a pH-sensitive enamel electrode as measurement half-cell are also used as mechanically more stable and, in principle, less maintenance-intensive pH sensors, for example, in the process industry. However, the semiconductor chips used in ISFET sensors are not stable at high temperatures and/or high pH values. Although enamel electrodes are mechanically robust, conventional enamel electrodes have a lower measurement accuracy compared to conventional pH sensors with pH glass electrodes. Currently available enamel or ISFET sensors are thus less universally usable than pH sensors with a conventional pH glass electrode.

Moreover, all of these electrochemical sensors require a reference electrode. A silver/silver chloride electrode is generally used as reference electrode. These electrodes usually have a housing in which a reference electrolyte having a high chloride concentration and a reference element contacting the reference electrolyte are contained. The reference element is often formed from a silver wire having a coating of silver chloride. During the sensor's measuring operation, the reference electrolyte is in electrolytic contact with the measuring liquid via a junction, for example a diaphragm, arranged in the housing wall. Via the junction, undesirable electrode poisons can penetrate into the reference electrode and/or an undesirably high level of chloride can escape from the reference electrolyte into the measuring liquid, which can lead to a drift in the reference potential. The crossover itself is susceptible to faults, e.g., it can become clogged in operation, which also leads to a distortion of measurement results.

In many areas, these sensors can nevertheless be used over relatively long periods of time by performing regular maintenance and/or calibration in order to eliminate faults, where applicable, and/or to compensate for aging-related sensor drift. However, such regular maintenance and/or calibration creates work and costs. Efforts have, therefore, been made for quite some time to provide pH sensors on the basis of an optical instead of electrochemical measuring principle. In principle, optical sensors are less susceptible to faults and thus can operate without maintenance over a longer period of time.

Hitherto, optical sensors which perform measurements of an analyte concentration on the basis of the so-called luminescence quenching, e.g., fluorescence quenching, have primarily become known. Such sensors usually comprise a measuring element having an indicator dye, e.g., a membrane in which molecules of an indicator dye are immobilized. The indicator dye is selected such that it can be excited to emit luminescence radiation, wherein the luminescence of the indicator dye is quenched by interaction with the analyte, in the case of the pH measurement, for example, with the hydronium ion. The intensity, the decay time or a phase shift of the luminescence radiation are thus a measure of the analyte concentration.

Disadvantages of previously known optical ion and pH sensors are their slow response time, only minimal suitability for uses at high temperatures, a temperature and/or ionic strength dependence of the sensor signal that cannot be compensated or is difficult to compensate, a systematic sensor drift due to leaching/bleaching of the indicator dye contained in the sensor membrane, low stabilities against disinfectants and solvents and the frequently complex synthesis of the indicator molecules. Previous systems therefore did not meet the expectations relating to long, maintenance-free operating times.

### SUMMARY

It is therefore the object of the present disclosure to specify an improved sensor based on an optical measuring principle for measuring the pH value of a measuring liquid. For example, the sensor should avoid the aforementioned disadvantages of the known optical pH sensors known from the prior art and based on the principle of luminescence quenching.

This object is achieved by an optical sensor according to the present disclosure. Advantageous embodiments are disclosed.

The sensor according to the present disclosure for measuring a pH value of a measuring liquid comprises: a sensor element comprising a surface intended for contact with the measuring liquid; at least one radiation source configured to emit electromagnetic transmission radiation reaching the sensor element, wherein at least a portion of the transmission radiation is converted into measuring radiation by reflection and/or scattering in the region of the surface; at least one radiation receiver configured to receive the measuring radiation and convert it into electrical signals; and a measuring circuit, for example, measuring electronics, connected to the radiation receiver and configured to determine a measured value representing the pH value of the measuring liquid from signals of the radiation receiver, wherein the surface intended for contact with the measuring liquid has a pH-sensitive component and a SERS-active component.

A pH-sensitive component is understood to mean a substance or a material which has protonatable or deprotonatable groups, or a material, e.g., glass or a polymer, which exchanges hydronium ions and/or protons in the measurement medium for ions of the material, e.g., lithium or sodium ions, or a material on which hydroxide ions and/or hydronium ions are adsorbed or chemisorbed. In contact with the measuring liquid, the pH-sensitive component causes, as a function of the pH of the measuring liquid, a reversible enrichment or depletion of hydronium ions or protons and/or, accordingly, a reversible enrichment or depletion of hydroxide ions in the region of the media-contacting interface of the sensor element. The hydronium and/or hydroxide ions, which are chemisorbed on the pH-sensitive component, or hydrogen or hydroxide bound to or in the pH-sensitive component, can be detected using SERS (surface-enhanced Raman spectroscopy). The intensity of the received measuring radiation is thus a measure of the pH value of the measuring liquid. By combining a SERS-active component with a pH-sensitive component in the region of the media-contacting surface of the sensor element, a chemically stable optical sensor which does not require additional indicator dye molecules can thus be provided for the pH measurement.

SERS is a spectroscopic method for detecting molecular vibrations. In the SERS method, the Raman scattering of molecules adsorbed or bound on a SERS-active surface is enhanced. Typical SERS-active surfaces are roughened surfaces of metals, for example, coin metals, such as gold, silver and copper. For example, in connection with the present disclosure described here, a roughened coin metal surface or a plurality of nanoparticles immobilized, for example, in or on a sensor surface of the sensor according to the present disclosure, is suitable as a SERS-active component.

The pH-sensitive component can comprise, for example, a pH-selective glass. The pH-sensitive glass can, for example, be a silicate glass containing at least one alkali metal oxide, preferably lithium oxide.

In one possible embodiment, the SERS-active component can be embedded in the pH-sensitive component. This is advantageous in connection with the aforementioned pH-sensitive glass but is also possible with other pH-sensitive components, for example, with one of the pH-sensitive components mentioned below.

In a further possible embodiment, the pH-sensitive component can comprise a layer of a pH-sensitive oxide, e.g., tantalum pentoxide (Ta₂O₅).

In a further embodiment, the pH-sensitive component can comprise indicator molecules. The latter can, for example, belong to one of the following substance classes: carboxylic acids, alcohols, phenols, amines, amides, oximes, nitriles, esters, thioesters, thiols, ethers, thioethers, amino acids, sulfonic acids and thiocarboxylic acids.

In this embodiment, the indicator molecules can be chemisorbed and/or covalently bonded to the SERS-active component.

The SERS-active component can comprise at least one coin metal or a platinum metal or an alloy containing a coin or platinum metal.

The SERS-active component may comprise a structured or textured surface or nanoparticles. Thus, the SERS-active component can be embodied, for example, in the form of a substrate or a layer of the coin metal or platinum metal or the alloy which is roughened and/or has a structure. The SERS-active component can also comprise a plurality of nanoparticles from the coin metal or platinum metal or the alloy which are embedded in the pH-sensitive component and/or are immobilized on a carrier.

The SERS-active component can comprise semiconductor nanostructures, e.g., nanowires or nanoparticles. The semiconductor nanostructures may be immobilized on a carrier and/or embedded in the SERS-active component. The semiconductor nanostructures, for example, nanoparticles, can have a layer or shell made of a coin metal or a platinum metal.

In an embodiment, the pH-sensitive component can be arranged on a base which reflects the transmission radiation. This makes it possible to increase the yield of measuring radiation since radiation reflected on the base passes through the pH-sensitive component a second time.

The at least one radiation receiver of the sensor may be configured to receive at least a portion of the transmission radiation converted by Raman scattering on the SERS-active component as measuring radiation and convert it into electrical signals.

The radiation receiver may, for example, be a spectrometer which is configured to extract Raman signals from the measuring radiation and to detect them as a function of the wavelength or a variable that can be converted into the wavelength. The measuring circuit may be an electronic evaluation device which can comprise and run software that is used to evaluate SERS spectra detected by means of the spectrometer.

### BRIEF DESCRIPTION OF THE DRAWINGS

The present disclosure is described in the following with reference to the exemplary embodiments shown in the figures. The same reference signs refer to the same components of the parts shown in the figures. The following are shown:

FIG. 1 shows a schematic longitudinal sectional representation of a sensor for the optical measurement of a pH value of a measuring liquid according to the present disclosure;

FIG. 2 shows a schematic representation of a sensor element of a sensor for the optical measurement of a pH value of a measuring liquid according to a first exemplary embodiment according to the present disclosure;

FIG. 3 shows a schematic representation of a sensor element of a sensor for the optical measurement of a pH value of a measuring liquid according to a second exemplary embodiment according to the present disclosure;

FIG. 4 shows a schematic representation of a sensor element of a sensor for the optical measurement of a pH value of a measuring liquid according to a third exemplary embodiment according to the present disclosure; and

FIG. 5 shows a schematic longitudinal sectional representation of a sensor for the optical measurement of a pH value of a measuring liquid according to a further exemplary embodiment according to the present disclosure.

### DETAILED DESCRIPTION

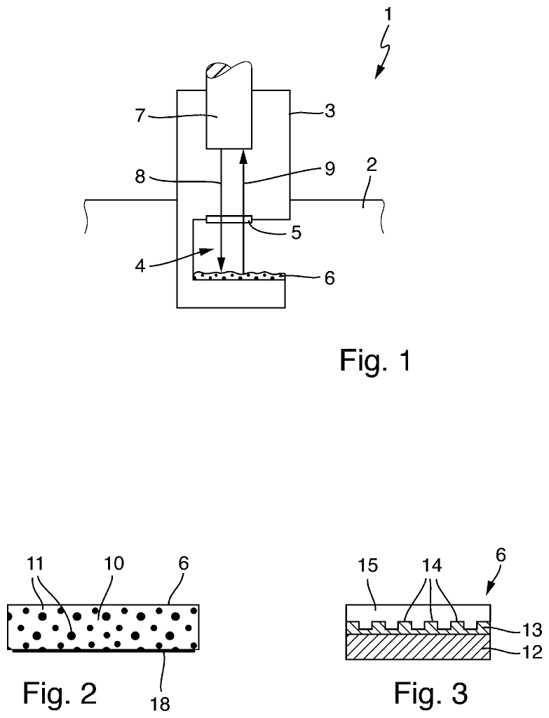

In a longitudinal sectional representation, FIG. 1 schematically shows a sensor 1 for the optical measurement of a pH value in a measuring liquid 2. The sensor 1 comprises a probe housing 3 having a specific end region for immersion into the measuring liquid 2. In the example shown in FIG. 1, the probe housing 3 has a substantially cylindrical shape, but other geometries are also conceivable. In the example shown here, the end region of the probe housing 3 forms a cuvette 4, which is filled by the measuring liquid 2 when the probe housing 3 is immersed into the measuring liquid 2 as intended. The cuvette 4 has a measuring window 5 on a first side. A sensor element 6 is arranged on the second side of the cuvette 4 opposite the measuring window 5.

In the present example, an optical fiber arrangement 7, e.g., in the form of an optical fiber bundle, from which electromagnetic transmission radiation 8 is irradiated into the cuvette 4 via the measuring window 5, is arranged in the interior of the probe housing 3. At the surface of the sensor element 6, the transmission radiation 8 is converted by reflection and/or scattering into measuring radiation 9 which passes back through the measuring window 5 into the interior of the probe housing 3 and to the optical fiber arrangement 7. In the present example, the optical fiber arrangement 7 is guided out of the probe housing 3 and in this way connects the sensor element 6 optically to a radiation source (not shown in FIG. 1) arranged outside the probe housing 3 and to a radiation receiver (not shown in FIG. 1) of the sensor 1 arranged outside the probe housing 3.

The optical fiber arrangement 7 is configured, on the one hand, to conduct the transmission radiation 8 generated by the radiation source to the sensor element 6. On the other hand, the optical fiber arrangement 7 is also configured to receive at least a portion of the measuring radiation 9 and to pass it to the radiation receiver. In the present example, the radiation receiver is designed as a spectrometer. In order to couple the transmission or measuring radiation in and out, the probe housing 3 may optionally contain an optical unit, which can contain optical elements for beam shaping and/or for filtering the transmission and/or measuring radiation. The radiation source may comprise a substantially monochromatic high-intensity radiation source, for example, a laser or one or more laser diodes, wherein at least a portion of the measuring radiation 9 is formed by Raman scattering of the transmission radiation 8 irradiated onto the sensor element 6.

The sensor 1, for example, a spectrometer serving as a radiation receiver, may comprise an optical device, e.g., an optical filter, which serves to remove the portion of the measuring radiation 9 formed by elastic Rayleigh scattering or pure reflection of the transmission radiation 8 on the sensor element 6. The spectrometer may be configured to register and process a Raman spectrum formed by Stokes scattering and/or by anti-Stokes scattering. Advantageously, the probe housing 3 is formed from an opaque material in order to avoid interference by extraneous light. In order to evaluate spectra, the sensor 1 may have, in addition to the spectrometer, measuring electronics, e.g., a measuring transducer, a computer or another electronic data processing device, which is configured to further process and evaluate the Raman spectrum registered, for example, by means of a software run by the measuring electronics and, where applicable, already processed by the spectrometer. Specifically, the measuring electronics in the present example are configured to determine a pH value of the measuring liquid 2 from the Raman spectrum.

In the embodiment of FIG. 1, the radiation source and the spectrometer are designed as device components remote from the sensor 1. The radiation is transmitted between the device components and the sensor 1 via the optical fiber arrangement 7. In an alternative embodiment, however, it is also possible for the radiation source and/or the spectrometer to be integrated in the probe housing 3.

The sensor element 6 comprises a surface which is intended for contact with the measuring liquid and has a pH-sensitive component and a SERS-active component. The pH-sensitive component is designed such that, as a function of the pH value of the measuring liquid, hydronium ions, protons or hydroxide are reversibly enriched or depleted in the interfacial region between the surface and the measuring liquid. The SERS-active component enhances the Raman scattering of the transmission radiation 8 of protons or chemisorbed hydronium ions bound to or in the pH-sensitive component or of hydroxide ions or hydroxide groups bound or chemisorbed to the pH-sensitive component. A SERS spectrum can thus be obtained from the measuring radiation 9 passed on by the optical fiber arrangement 7 to the spectrometer, on the basis of which SERS spectrum a concentration of protons, hydronium ions and/or hydroxide present in the surface region of the sensor element 6 can be deduced, which in turn is a measure of the pH value of the measuring liquid. Consequently, the pH value of the measuring liquid can be determined from the SERS spectrum determined by means of the sensor 1, by evaluating an intensity of one or more spectral properties (“peaks”) of the detected SERS spectrum. Based on the detected intensity of such a peak, the pH value of the measuring liquid can be determined, for example, by comparison with calibration data or on the basis of a calibration function determined from calibration measurements and stored in a memory of the measuring electronics.

The pH-sensitive component can be designed as a layer or form a part of a layer of the sensor element 6. For example, the pH-sensitive component can contain a pH-sensitive glass, as is also used for pH-sensitive glass membranes of conventional glass electrodes for potentiometric pH measurements. Possible examples are silicate glasses containing at least one alkali metal, e.g., sodium or lithium.

The SERS-active component of the sensor element 6 can be a SERS-active structure, e.g., a surface-structured layer of a coin metal or noble metal, e.g., copper, silver, gold or platinum, or a layer of a semiconductor material, e.g., silicon. The surface structure of such a layer can be produced by roughening the surface or by a targeted production of nanostructures, e.g., nanoclusters, nanometer-sized islands or nanowires, on the surface. This can be done by abrasive processes or by depositing nanostructures, for example, by depositing nanoparticles on the surface. It is also possible for the SERS-active component to have a plurality of nanostructures, e.g., nanoparticles or nanowires, which are embedded in a layer formed from the pH-sensitive component. If the SERS-active component is formed as a layer with structured surface, the pH-sensitive component can be designed as a layer arranged above the structured surface. Exemplary embodiments of the sensor element 6 are illustrated below with reference to FIGS. 2 through 4.

FIG. 2 schematically shows a sectional view through a sensor element 6 according to a first exemplary embodiment of the present disclosure. The sensor element 6 is formed from a layer 10 of a pH-sensitive, lithium-containing silicate glass, into which a plurality of nanoparticles 11 is embedded. These may, for example, be particles of a coin metal or platinum metal or semiconductor nanoparticles. The nanoparticles 11 may have an average size, i.e., for example, an average diameter of 1 to 1000 nm, advantageously 10 to 100 nm, or preferably 25 to 50 nm. The characteristic distances of the nanoparticles 11 from one another are advantageously <20 nm, preferably 1 to 10 nm, more preferably 1 to 5 nm. The plurality of nanoparticles 11 thus distributed forms a SERS-active structure for SERS measurements for pH measurement in a measuring liquid.

Such a glass layer 10 with embedded nanoparticles 10 may be produced, for example, by precursor compounds for forming metal nanoparticles being contained in the glass batch in the glass melt or by directly adding nanoparticles into the glass melt, or an electrofloat process. Such methods are known in principle to those skilled in the art.

In contact with the measuring liquid, the pH-sensitive glass forms a source layer into which protons can diffuse from the measuring liquid, while lithium ions escape from the glass into the measuring liquid. The concentration of the protons in the source layer is a function of the pH value of the measuring liquid. Thus, an intensity of the Raman scattering, which is surface-enhanced by the nanoparticles 11, of the protons bound in the source layer is a measure of the pH value of the measuring liquid.

In the example of FIG. 2, a reflective base in the form of a reflecting coin metal or platinum metal layer 18, e.g., made of gold, silver or platinum, is arranged on the rear side of the layer 10 made of the pH-sensitive glass and facing away from the media-contacting surface of the sensor element 6. Transmission radiation, which is incident from the front side, is reflected on the surface of said layer 18 and passes through the interfacial region between the sensor element 6 and the measuring liquid 2 again, which leads to an increase in the yield of Raman radiation.

FIG. 3 schematically shows a sectional view through a sensor element 6 according to a second exemplary embodiment of the present disclosure. The sensor element 6 comprises a substrate 12, e.g., made of quartz glass. A coating 13 made of coin or platinum metal, e.g., gold, is applied to the substrate and is structured by an abrasive treatment, e.g., laser ablation or electrochemical structuring. The coating 13 thus has a structure comprising structural elements 14, e.g., nanoislands, nanoparticles, nanocolumns or nanowires. Advantageously, a diameter of the structural elements 14 is in the magnitude of 1 to 1000 nm or between 1 and 100 nm, preferably between 25 and 50 nm. The average distance of the structural elements 14 from one another is advantageously less than 20 nm, preferably between 1 and 10 nm, very analogously as described above for the nanoparticles 11 embedded in the pH-sensitive layer 10. The structure does not necessarily have to be regular but should contain regions in which enhancing elements occur at characteristic distances, e.g., the aforementioned average distances. In an alternative embodiment, it is also possible that the sensor element 6 does not have a substrate made of quartz glass but is formed completely as a body from the coin or platinum metal, e.g., as a metal plate. In this case, the surface of the body is structured or textured in a manner corresponding to the previously described metal coating 13.

The structured coating 13 or surface forms the SERS-active component of the sensor element 6 according to the present second exemplary embodiment. A pH-sensitive layer 15, e.g., in the present case made of tantalum pentoxide, Ta₂O₅, is arranged above the coating 13 and forms the pH-sensitive component of the sensor element 6. In an alternative embodiment, the pH-sensitive layer 15 may also be formed from a pH-sensitive glass. In contact with the measuring liquid, as a function of the pH value of the measuring liquid, hydronium ions and/or hydroxide ions reversibly settle on the pH-sensitive surface of the pH-sensitive layer 15 so that the concentration of the hydronium ions or hydroxide ions in the interfacial region between the surface of the pH-sensitive layer 15 and the measuring liquid is a measure of the pH value of the measuring liquid. The pH value of the measuring liquid can thus be determined on the basis of signals originating from the hydronium ions or hydroxide ions adsorbed on the surface in the SERS spectrum determined by means of the sensor 1.

In an alternative embodiment of the sensor element 6, the SERS-active component can be produced by depositing a plurality of nanoparticles, e.g., galvanically or by a deposition process from the gas phase, on the substrate 12 and thus forming a SERS-active coating.

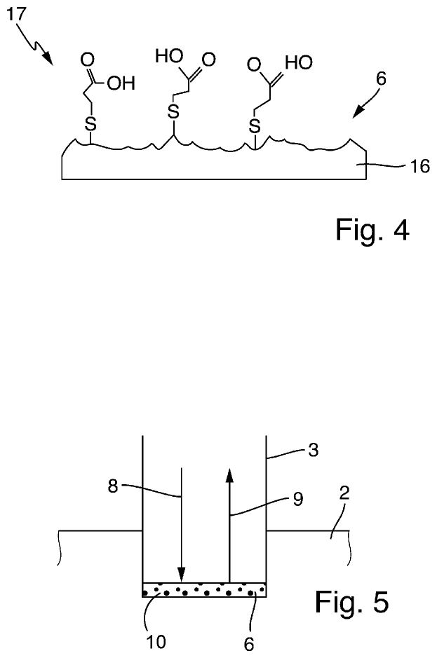

FIG. 4 schematically shows a sectional view through a sensor element 6 according to a third exemplary embodiment of the present disclosure. Here, the SERS-active component is formed by a SERS-active substrate 16, whose surface is roughened and which is made of a coin or platinum metal, the surface of which may have similar properties to the surface of the coating 13 of the sensor element previously described with reference to FIG. 3. The pH-sensitive component of the sensor element 6 according to the present example is formed by a pH-sensitive layer 17. The layer 17 includes a plurality of molecules bound to the surface of the SERS-active substrate 16 with reversibly deprotonatable functional groups. In the present example, the molecules are bound to the surface of the SERS-active substrate 16 by a thiol group, which comprise a carboxylic acid group as reversibly deprotonatable functional groups. Alternatively, instead of carboxylic acids, the molecules may also be alcohols, phenols, amines, amides, oximes, nitriles, esters, thioesters, thiols, ethers, thioethers, amino acids, sulfonic acids, or thiocarboxylic acids. The degree of protonation of the corresponding functional group is a function of the pH value of the measuring liquid into which the surface of the sensor element 6 modified with the layer 17 is immersed. The pH value of the measuring liquid can thus be determined on the basis of signals originating from the functional group of the molecules forming the layer 17 in the SERS spectrum determined by means of the sensor 1.

In a modification, it is possible to design the sensor element in such a way that different reversibly deprotonatable functional groups each with different pKa values are connected to the surface of the coating 13. This can be realized, for example, by binding molecules of two or more different substances or acids/bases having different pKa values. This enables a wider pH measuring range of the sensor 1.

FIG. 5 schematically shows a longitudinal section of a further exemplary embodiment of the present disclosure of a sensor 1 for the optical measurement of the pH value of a measuring liquid 2 by means of SERS spectroscopy on a sensor element 6 comprising a pH-sensitive component and a SERS-active component.

In this example, the probe housing 3 may again have a cylindrical shape and can be immersed into the measuring liquid 2 as a probe. The sensor element 6 may be designed as described with reference to FIG. 2. Optionally, the layer 10 made of pH-sensitive glass can be applied to a material, for example quartz glass, which is transparent to the transmission radiation 8 and the measuring radiation 9. However, it is also possible for the layer 10 to be of such a thickness that it is self-supporting. In this embodiment of the sensor 1, the transmission radiation passes through the sensor element 6 to the interface between the sensor element 6 and the measuring liquid 2 and is converted there into measuring radiation 9 by Raman scattering in the interfacial region. A portion of the measuring radiation 9 returns to an optical fiber arrangement (not shown in FIG. 5), which guides it to a spectrometer for detecting a SERS spectrum. In order to increase the yield of the measuring radiation 9 returning to the radiation receiver, here the spectrometer, concentrator optics, e.g., a Fresnel lens, can be provided in the beam path of the measuring radiation 9. The measuring radiation 9 can be guided via an optical fiber bundle to the concentrator optics and/or to the spectrometer in order to minimize losses.

We claim:

1. A sensor for measuring a pH value of a measuring liquid, the sensor comprising:
a sensor element comprising a surface adapted to contact the measuring liquid;
at least one radiation source configured to emit electromagnetic transmission radiation incident upon the sensor element, wherein the sensor element and the at least one radiation source are configured such that at least a portion of the transmission radiation is converted into measuring radiation by reflection and/or scattering in a region of the surface adapted to contact the measuring liquid;
at least one radiation receiver configured to receive the measuring radiation and convert the measuring radiation into electrical signals; and
a measuring circuit connected to the at least one radiation receiver and configured to determine a measured value representing the pH value of the measuring liquid from the electrical signals of the at least one radiation receiver,
wherein the surface adapted to contact the measuring liquid comprises a pH-sensitive component and a surface-enhanced Raman spectroscopy active (SERS-active) component.

2. The sensor of claim 1, wherein the pH-sensitive component comprises a pH-selective glass.

3. The sensor of claim 2, wherein the pH-sensitive glass is a silicate glass containing at least one alkali metal oxide, preferably lithium oxide.

4. The sensor of claim 4, wherein the at least one alkali metal oxide includes lithium oxide.

5. The sensor of claim 2, wherein the SERS-active component is embedded in the pH-sensitive component.

6. The sensor of claim 1, wherein the pH-sensitive component comprises a layer of a pH-sensitive oxide.

7. The sensor of claim 6, wherein the pH-sensitive oxide is tantalum pentoxide (Ta₂O₅).

8. The sensor of claim 1, wherein the pH-sensitive component comprises indicator molecules.

9. The sensor of claim 8, wherein the indicator molecules comprise at least one of carboxylic acids, alcohols, phenols, amines, amides, oximes, nitriles, esters, thioesters, thiols, ethers, thioethers, amino acids, sulfonic acids and thiocarboxylic acids.

10. The sensor of claim 8, wherein the indicator molecules are chemisorbed and/or covalently bonded to the SERS-active component.

11. The sensor of claim 1, wherein the SERS-active component comprises at least one coin metal, a platinum metal or an alloy containing a coin or platinum metal.

12. The sensor of claim 11, wherein the SERS-active component comprises a structured or textured surface or nanoparticles.

13. The sensor of claim 1, wherein the SERS-active component comprises semiconductor nanoparticles.

14. The sensor of claim 1, wherein the pH-sensitive component is disposed on a base configured to reflect the transmission radiation.

15. The sensor of claim 1, wherein the at least one radiation receiver is configured to receive at least a portion of the transmission radiation converted by Raman scattering on the SERS-active component as the measuring radiation and convert the measuring radiation into the electrical signals.
